(19) United States
(12) Patent Application Publication
(10) Pub. No.: US 2004/0247832 A1
(43) Pub. Date: Dec. 9, 2004

(54) Label with improved anti-forgery security

(76) Inventors: Arne Koops, Breitenfelde (DE); Michael Blumel, Oststeinbek (DE)

Correspondence Address: Norris McLaughlin & Marcus, 30th Floor, 220 East 42nd Street, New York, NY, 10017, US

(21) Appl. No.: 10/494,166

(22) PCT Filed: Nov. 26, 2001
(86) PCT No.: PCT/EP01/13724

(51) Int. Cl. B42D 15/00

(52) U.S. Cl. 428/156; 283/81

(57) ABSTRACT

Anti-forgery security label comprising at least one lacquer coat which has been applied to a printed support film and then hardened.

The invention relates to a label with enhanced proof against counterfeiting, comprising a varnish layer, particularly of thermoset varnish for laser inscription.

For the identity marking of parts on vehicles, machinery, electrical and electronic devices, use is being made increasingly of technical labels as, for instance, model identification plates, process control labels, guarantee badges, and testing plaquettes.

Inherent in many of these applications is the need for a more or less pronounced degree of proof against counterfeiting. This proof applies primarily to the period of attachment and to the total period of use on the part to be marked. Removal or manipulation ought to be impossible without destruction or visible, irreversible alteration.

In order to increase further the proof of the labels against counterfeiting the labels themselves are increasingly being required to make a contribution to security by means of a particular design.

In especially sensitive areas of application there must also be a security stage for the production of the labels. If it were too easy to acquire and mark such labels and to produce copies, third parties would be able to carry out unauthorized circulation of articles.

This additional proof against counterfeiting must, however, not hinder subsequent identification of the applied label for originality by means of a rapid, unambiguous, simple, and nondestructive method.

High-performance controllable lasers for burning marks such as text, codes, and the like are currently widespread. The requirements imposed on the material that is to be inscribed include the following:

It should be capable of being rapidly inscribed.

A high degree of spatial resolution capability should be achieved.

It should be extremely simple to use.

The decomposition products should not be corrosive.

For special cases, moreover, further requirements are imposed.

The indicia should have sufficiently high contrast to be legible without error at a distance even under unfavorable conditions.

Heat resistance should be high; for example, up to more than 200° C.

Good resistance to weathering, water, and solvents is desired.

Known materials used for this purpose, such as printed paper, Eloxed aluminum, painted metal or PVC sheets, do not meet all of these requirements.

DE U 81 30 861 discloses a multilayer label comprising a thin and a thick, self-supporting, opaquely pigmented varnish layer. Both layers are composed of a solventlessly applied and electron beam cured varnish, the layer thicknesses being different. The label is inscribed by using a laser to burn away the upper, thinner varnish layer, so that the lower, thicker varnish layer becomes visible, said lower layer preferably being of a contrasting color to the first layer.

This inscription is a kind of gravure, ruling out possibilities for manipulation as exist with traditional imprints using inks. As a result of the base materials used and the production process, the label is made so brittle that its removal from the substrates without destruction is impossible.

Laser labels of this kind are employed in particular for rational and variable inscription for the purpose of producing plate sets. These plate sets contain the total number of labels needed, for example, on components that require labeling in a motor vehicle (VIN plate, plates relating to tire pressure, trunk loading, key data for engines and ancillary equipment, etc.).

EP 0 645 747 A specifies a laser-inscribable, multilayer label material composed of a first layer and a second layer which is visually different from the first layer, said first layer being removable by means of laser radiation in accordance with a desired text image or print image, in the course of which the surface of the second layer is rendered visible. Disposed between the layers, furthermore, is a transparent polymer sheet which forms a carrier layer.

DE 44 21 865 A1 specifies a monolayer laser label comprising a carrier layer made of plastic, said layer comprising an additive which changes color under laser irradiation. The carrier layer is coated on one side with a self-adhesive composition which where appropriate is covered with a release paper or release film.

All of the labels set out above, following application to an article, provide a high level of proof against counterfeiting, since the labels can be inscribed only with technically refined lasers which are therefore expensive and hence not universally accessible, with the consequence that the equipment needed to copy or alter said labels has generally been more expensive—at least in the past—than the product in question. Moreover, the high brittleness of the material results in destruction of the label in the case of attempts at manipulation or removal.

With the progress of technology, however, lasers of this kind have become more and more affordable, so making it worthwhile in an increasing number of cases to acquire such lasers, particularly in the case of relatively large products such as, for example, motor vehicles, which are provided with such a label for the purpose of identity marking in the engine compartment as well as elsewhere.

In this situation, the production of unauthorized copies is made much easier by the ready and freely accessible supply of laser label stock and the existence, now widespread, of laser inscription units.

A very important part is played by labels in automotive engineering, since the marking of vehicles, vehicle parts, and other original components is a given requirement of the market, particularly in the automobile industry, owing to the necessity of the proof of origin obligation and of traceability.

For a long time it was it was state of the art to use for this purpose the embossed metal plates already mentioned, which were fastened to the corresponding component using rivets. Besides great operating cost disadvantages, deficiencies in flexibility, and the logistical complexity, this technology also has the drawback, on which there is particular focus at the present time, that these riveted metal plates can be removed without great effort and replaced by copies.

As a result of these fundamental drawbacks, the laser label technology has become widespread particularly in the automobile industry.

As far as proof against counterfeiting is concerned, the laser sheet such as is known from DE U 81 30 861 and is available, for example, as tesa 6930® from Beiersdorf is, as already stated, a product with a very brittle structure which makes it an excellent basis for documenting, and hence frustrating, any attempts at manipulation.

Nondestructive removal of the laser-inscribed label in one piece from its original bonding substrate requires a great deal of effort and particular conditions.

This effort is so great that said label easily passes all current detachability tests by the major testing institutions, such as, for example, “Prüfung von Fabrikschildern aus Platten, Blechen und Folien sowie deren Befestigung durch Kleben” [Testing of plant plates made from plaques, metal sheets, and foils, and their fastening by adhesive bonding] by the German motor transport office, and “Marking and Labeling System Materials MH 18055” by Underwriters Laboratories Inc.

This certified proof against counterfeiting, which must always be seen in relation to the effort needed for manipulation, is having to face up to heightened requirements concerning proof of originality. This means that by means of a bonded laser label it should be documented that the marked component is an original. Since, as already mentioned earlier, both the laser sheet and laser inscription units are freely available on the market, there exists here a possibility for organized criminality on a large scale. Using the aforementioned hardware and the freely available laser sheets, stolen vehicles can be furnished with new labels which are difficult if not impossible to distinguish from the actual original labels.

This is precisely the point where the solution provided by the invention begins and where it distinctly restricts, if not indeed entirely prevents, the possibilities for forgeries and for trafficking in imitations.

This is so by virtue of the fact that the label for use in the automobile is individualized for a specific customer and supplied exclusively to that customer.

This individualization has to meet two important criteria, namely

the label must be readily and rapidly identifiable, and

the label must be uncopyable.

By means of these two criteria it is possible to ensure that only the proper authority, in this case the automaker, is able to define and identity-mark components as originals.

First attempts at individualizing the carrier material of the label are disclosed in DE 199 04 823 A1. It describes a process for producing a film, in which first of all a support carrier sheet is embossed by means of an embossing tool, the embossing tool having holographic structures. A film is then produced on the embossed support carrier sheet so that at least one hologram is reproduced on the film.

It is an object of the invention to provide a label which meets the above-mentioned requirement of enhanced proof against counterfeiting and further possesses, in particular, a high contrast, high resolution capability, high temperature stability, and ease of use.

This object is achieved by means of a label as obtainable in accordance with claim 1. The subclaims provide particularly advantageous embodiments of the label.

The invention accordingly provides a label with enhanced proof against counterfeiting, comprising at least one varnish layer, obtainable by applying the varnish layer, more preferably solventlessly, to a printed support carrier sheet and subsequently curing it.

It has proven advantageous if the varnish layer is self-supporting and opaquely pigmented and also if the varnish layer is electron beam cured.

It has also proven advantageous if the support carrier sheet is a polymer film, in particular of polyester.

The support carrier sheet is printed in particular by the flexographic process, since the UV flexographic printing process possesses a very high degree of freedom in terms of the design of geometries and is able to provide good print quality at a very low price particularly for web materials ranging from paper to film. With this technology it is possible to transfer lines, fields, images, logos, text, etc. from printing plate to printing substrate, in different sizes and kinds.

The most important factors influencing this process are:

prepress stage (reprographic elaboration of the printing plate)

printing plate

print format construction

material to be printed

engraved roller

printing ink

coloring

print tension

In the above-described application of the counterfeitproof, laser-inscribable label, logos and text of varying complexity are preferentially required by automakers; UV flexography is very suitable for use here.

For this purpose, a printing plate bearing the logos and text is wetted with printing ink, which is transferred to a polymer film. The printing ink may be cured on the film by means of physical activation (thermally, radiation-chemically). To this end the ink should undergo a high level of composite adhesion to the film substrate; this is vital for further processing. Print anchorage should be tested prior to further processing, using the cross-cut test (DIN EN ISO 2409). In the cross-cut test the print should achieve a rating of at least Gt 02.

In order to achieve a high level of composite adhesion/print anchorage it is necessary to practice appropriate selection and/or formulation of the printing ink as a function of the film material and/or to use a pretreatment technique for the print film. With preference here it is possible to choose corona treatment, which can be used in line with the printing operation. When a PET film is used, the surface tension should be adjusted to >50 mN/m. This can be measured using customary test inks.

Depending on the UV lamp, the UV curing should possess a percentage output setting of between 50% to 100%, in order to ensure sufficient flexibility of the print for the subsequent processing operations.

In order subsequently to achieve a visible and sensorially perceptible impression on the laser label, the print should have a height of from 0.1 μm to 15 μm. It is preferred to choose a height from 1 to 5 μm. In addition, the esthetics and character of the print can be varied by means of the profile of the printed dots.

For the realization of the invention it is also possible to use the other conventional printing techniques, which are known as relief printing processes. They include letterpress and screen printing.

The support carrier sheet can be printed with a wide variety of designs, company logos or advertising for example. The printing of the support carrier sheet produces a negative impression on the visible surface of the first varnish layer of the label of the invention.

It is particularly preferred if in the first varnish layer the impression of the printed support carrier sheet is present as a depression of from 0.1 to 15 μm, preferably from 1 to 5 μm.

In one advantageous embodiment of the invention the label is composed of

a) a carrier layer made of plastic and

b) comprising an additive which under laser irradiation exhibits a marked change in color, said layer

c) being coated on one side with a self-adhesive composition which is

d) where appropriate covered with a release paper or release film.

The carrier layer is composed of a varnish, in particular of a cured varnish, preferably a radiation cured varnish, with particular preference an electron beam cured polyurethane acrylate varnish. In one alternative embodiment the carrier layer is composed of a polybutylene terephthalate.

The carrier layer has a thickness of preferably from 10 to 200 μm, in particular from 50 to 100 μm.

Suitable carrier layers are composed, moreover, of plastics such as polyesters, poly(meth)acrylates, polycarbonate, and polyolefins, and of radiation curable systems such as unsaturated polyesters, epoxy acrylates, polyester acrylates, and urethane acrylates, such as are also used for UV printing inks, especially those comprising a base polymer according to DE U 81 30 861, namely aliphatic urethane acrylate oligomers.

The additive may be a pigment, especially copper hydroxide phosphate or Iriodin, and titanium dioxide may be used as well as the additive.

The additive can be inserted.

Suitable additives are, in particular, color pigments and metal salts, especially copper hydroxide phosphate or else Iriodin, a pearl luster pigment available commercially from Merck. These additives are admixed to the base polymer (as described, for example, in DE U 81 30 861) in particular in an order of magnitude ranging from several parts per thousand up to a maximum of 10 percent by weight, preferably in amounts from 0.1 to 10% by weight, in particular from 0.5 to 5% by weight, based on the total weight of the carrier layer. Following production of sheet material by means of known techniques such as extrusion, casting, coating, etc. with subsequent radiation-chemical crosslinking where appropriate, such films are coated with self-adhesive compositions, which are to be adapted to the subsequent end-use applications.

Covering with siliconized release paper then produces the typical construction for stock material from which labels can be manufactured.

When the standard lasers are used, especially the widespread solid state Nd-YAG lasers with a wavelength of 1.06 μm, a (marked) change in color takes place at the point where the laser strikes the surface of the material, giving sharply defined, high-contrast inscriptions and identity markings.

In a further advantageous embodiment a second, in particular self-supporting, opaquely pigmented varnish layer is applied, preferably solventlessly, to the first varnish layer, and is subsequently cured, in particular electron beam cured.

It has been found particularly advantageous if the second varnish layer contains at least 5% by weight, preferably 7% by weight, of an additive which is fluorescent or phosphorescent or which is suitable for magnetic or electrical characterization.

In another advantageous embodiment, either the first varnish layer or the side of the second varnish layer opposite to the first varnish layer is printed with an ink comprising a fluorescent or phosphorescent additive.

In the case of two-layer and multilayer labels, a suitable additive may be incorporated into the second varnish layer, which is essential for the text. The first varnish layer itself, for the high gloss model identification plates, for example, therefore remains unchanged; only at the laser engraving stage is the second varnish layer partially exposed at the sites of the inscription. Where the second varnish layer—white here, for example—includes color pigments, color particles, colored fibers, and the like, these become visible at the engraved sites.

The color-imparting particles may comprise fine color pigments or else, preferably, visible particles with a size of the order of from 0.1 to 5 mm. The use of finely ground color pigments produces a slight change in shade of the indicia, the visible particles a characteristic color mosaic. Absent auxiliaries, the use of daylight fluorescent inks allows the “fingerprint” to be seen, which is often undesirable. It is therefore preferred to use color pigments or particles which do not absorb in the range of visible light and hence are normally invisible—only when the label is illuminated with a lamp of appropriate wavelength are the color pigments excited and luminesce characteristically.

Besides color pigments excited by means of IR radiation, primarily UV-active systems are employed. Also suitable in principle are luminescent substances which are excited by electron beams, X-rays and the like, and also thermochromic pigments which undergo a reversible color change as a response to a change in temperature—in these cases, however, carrying out an identification procedure on the bonded label is awkward in practice and more complicated than visualization by means of light of an appropriate wavelength.

When selecting the color pigments it should be ensured that they are sufficiently stable for the label production process (film production, adhesive coating) and do not undergo irreversible alteration under the process conditions (possibly thermal drying, electron beam or UV curing, and the like). For long-term applications of the labels it is advantageous for these luminescent substances, which are generally sensitive, to be embedded in a polymer matrix and additionally protected by the cover layer. Additional measures to counter mechanical abrasion, and protection against direct oxygen and water contact, are unnecessary.

For use in accordance with the invention it is possible to employ a variety of color pigments and dyes. The most widespread are long-afterglow (phosphorescent) pigments or fluorescent pigments which are excited solely or predominantly by UV radiation and which emit in the visible region of the spectrum (as an overview, see, for example, Ullmann's Enzyklopadie der technischen Chemie, 4th edition, 1979, Verlag Chemie). Also known, however, are IR-active luminescent pigments. Examples of systems featuring UV fluorescence are xanthenes, coumarins, naphthalimides, etc., sometimes referred to in the literature under the rubric of “organic luminescent substances” or “optical brighteners”. The addition of a few percent of the luminescent substances in question is sufficient, with binding into a solid polymer matrix, in particular, being favorable in respect of luminosity and stability. Use may be made, for example, of formulations comprising RADGLO® pigments from Radiant Color N. V., the Netherlands, or Lumilux® CD pigments from Riedel-de Haën. Inorganic luminescent substances are also suitable; metal sulfides and metal oxides, generally in conjunction with appropriate activators, have proven favorable as long-afterglow substances, particularly with emission of light in the yellow region. These substances are available, for example, under the tradename Lumilux® or, as luminescent pigments improved in respect of stability, luminosity and duration of afterglow, under the tradename LumiNova® from Nemoto, Japan.

These dyes and color pigments, listed by way of example, are incorporated into the formulation of the second varnish layer in amounts of from 0.1 to 50% by weight, preferably at from 1 to 25% by weight, with very particular preference at 7% by weight, and the varnish layer is applied. Following final adhesive coating of the second varnish layer and, where appropriate, lining with release paper or release film, the label stock material is available for customer-specific utilization.

After punching/laser cutting of the desired label geometries, and final inscription by means of a laser beam with text, barcodes, logos, etc., the label is present in its final form. If, for example, long-afterglow pigments have been incorporated into the varnish layer, upon corresponding excitation of the luminescent pigments the label displays a characteristic afterglow in the region of the laser inscription and at the edges, permitting its easy and rapid identification as an original label. Apart from the specific light source and, where appropriate, eye protection to counter disruptive ambient light, no other expensive equipment is needed—following testing, the label remains unchanged.

Labels of this kind, comprising luminescent substances—especially those which emit in the visible wavelength range only after UV or IR excitation—in the second varnish layer, are also suitable for in-register production (printing, punching, application, etc.). Instead of separately applying register marks or control marks, the light emission of the varnish layer can be utilized for this purpose in processing: in particular following inscription and cutting of the labels by means of a laser beam from unpunched roll material, the excitation and emission can be utilized in a downstream control unit with appropriate equipment, at a defined point on the label, as a control mark for further processing steps or for producing the next label.

An alternative to the use of luminescent substances is the incorporation into the second varnish layer of substances which can be detected magnetically or electrically. Magnetic field changes as in the case of alarm labels for articles of clothing, for example, are possible in principle although not predestined for the fields of application (identity marking of machinery parts and automotive parts predominantly made of metal).

On the other hand it is appropriate, as a hidden security step, to add substances to the second varnish layer that lead to said layer having electrical conductivity. By means of suitable measuring equipment, which is transportable, easy to use, and inexpensive to purchase, and suitable electrodes, the conductivity of the varnish layer can be determined directly on the bonded label. The electrodes are attached at two different points, A and B, of the varnish layer, and a voltage is applied. If there is a coherent electrical conductivity between A and B, it is possible to measure a current flow which may have a characteristic value in dependence on the nature and amount of the additive used. Since, even when the label is used directly on metals, the varnish layer is separated from the conductive metal by the electrically insulating adhesive layer, there is no risk of erroneous measurements.

Falsification by subsequent manipulation is prevented in particular by the fact that the conductivity measurement may be made not only from edge to edge of the labels but also between any desired points exposed by laser treatment: To allow conductivity to be detected here, the complete varnish layer must be coherently and three-dimensionally conductive, which can only be ensured as part of the original production process. A laser-inscribable label of this kind can be produced by adding electrically conductive substances to the formulation of the varnish layer; this may be done in addition to the existing pigments or else at least partly in replacement of the pigments present, in order to attain the good processing properties of the varnish pastes. Suitable conductive additives include in principle electrically conductive metallic, organic, polymeric, and inorganic substances, preference being given to the use of metals. Especially for white or pale varnish layers, the inherent color of the conductive additive is a factor in selection. Conductive carbon black is likewise suitable, albeit only for black or dark varnish layers.

In order to ensure good conductivity, there should be a minimum, limiting concentration of additive, so that sufficient particles are present in the varnish layer to touch and have contact with one another. Below this limiting concentration, a conductive path from A to B is no longer ensured in the three-dimensional microstructure of the base layer. It is therefore preferred to use metallic particles, preference being given to fibers having a high ratio of length to cross section, since in this case it is possible to ensure three-dimensional conductivity with lower concentrations than with spherical particles; additionally, the alteration in color of the varnish layer by the fibers is reduced. From cost/benefit analysis, the metals used are preferably copper, iron, aluminum, and steel, and the alloys of these metals, although expensive, highly conductive metals such as silver and gold are suitable as well. The fiber dimensions are from 0.1 to 50 mm length with cross sections of from 1 to 100 μm, preference being given to using metal fibers having a diameter of from 2 to 20 μm with a cross section-to-length ratio of approximately 1:100 to 1:1000. Such fibers are incorporated homogeneously into the known formulation at from 0.5 to 25% by weight, preferably from 2 to 10% by weight, and the formulation is applied and cured in accordance with DE U 81 30 861. Adhesive coating and lining with release paper provides label material which can be inscribed by laser beam. As a result of the removal of the top varnish layer, the indicia of the second varnish layer are exposed in the region of laser inscription—when a voltage is applied by way of suitable electrode contact to two different points A and B in these indicia, a conductivity is measured which is characteristic of the varnish layer and is determined by, inter alia, the nature and amount of the conductive additive. Hence it is possible to produce customer-specific label stock material by means of defined formulations.

In the stated further advantageous embodiment an ink with a fluorescent or phosphorescent additive is printed on the first varnish layer or on the side of the second varnish layer opposite the first varnish layer.

Use is made in particular of special inks containing luminescent substances, daylight-fluorescent inks or, in particular, color pigments which are excitable by IR or UV radiation.

After the printing, the resulting material can be coated with self-adhesive composition, dried, and lined with release paper, in the standard fashion.

In relation to the long-afterglow pigments (phosphorescent pigments) or fluorescent pigments reference is made to the above description in relation to the additives.

Also suitable here in principle are luminescent substances which are excitable by electron beams, x-rays, and the like, and also thermochromic pigments, which undergo a reversible color change when there is a change in temperature; the use of electrically conductive inks is also possible.

This additional marking is invisible from the facing side in the region of the laser inscription (except in the case of a transparent or translucent layer), and can only be seen at the edge all around the label. In order to ensure clear visibility at the label edge, strongly luminescent color pigments are printed in a sufficient layer thickness. Despite this, the additional security is hidden and therefore unapparent. This security marking is protected from external access by the fact that the print lies embedded between the label sheet and the adhesive layer: there is no risk of subsequent manipulations, since detachment of the known laser labels is impossible without destruction of the varnish film.

Customer-specific “fingerprints” in the labels can be produced by printing different colors or patterns. In particular, regular lines and line patterns produce characteristic patterns of luminescent dots at the label edges, and are also particularly inexpensive and economical with material. Following punching or laser cutting of the label and application to the bonding substrates, and given an appropriate source of illumination, a pattern which is characteristic in terms of colors and geometry is evident at the edge of the label.

The advantage of this security marking is manifested especially from a logistical standpoint and in terms of costs. It is possible to employ commercial printing inks and unspecific label sheet material, with the latter being otherwise producible customer-specifically. Since standard stock material of this kind is only used as an intermediate by the label manufacturers themselves for their own production, and is not freely available on the market, however, unauthorized access is prevented. Moreover, small batch sizes and short supply times are possible.

The inventive embossing makes use, for example, of the two-layer sheet material described in DE U 81 30 861. Prior to coating and lining with release paper, the reverse is, however, printed over the whole area, in an endless pattern or, in particular, with defined geometries. Printing inks containing a high fraction of luminescent pigments are applied preferably by screen printing so as to give film thicknesses in the range from 0.5 to 50 μm, preferably from 2 to 25 μm.

Following adhesive coating and lining, the label stock material is punched or cut by laser beam to the desired formats and sizes. In the bonded state these labels give no indication of a hidden falsification step provided the luminescent substances chosen emit light as a result of excitation with light outside the visible region; only following irradiation with suitable light sources does excitation of the luminescent pigments take place at the edges of the label. Here, and here only, therefore, markings are visually perceptible which result in a defined pattern of luminescent dots. The size of the luminescent dots can be varied by means of different line widths and line heights. Accordingly, a readily detectable security stage can be realized simply, cost effectively, and, where necessary, customer-specifically by way of the selection of geometry and colors.

The first varnish layer, formed from a cured, i.e., crosslinked, varnish, has a thickness of preferably from 1 to 20 μm, in particular from 5 to 15 μm; the second varnish layer has a thickness of preferably from 20 to 500 μm, in particular from 30 to 100 μm.

In principle, four types of varnish can be used for the objective of the invention, provided their stability is adequate; for example, acid curing alkyd-melamine resins, addition crosslinking polyurethanes, free radically curing styrene varnishes, and the like. Particularly advantageous, however, are radiation curing varnishes, since they cure very rapidly without laborious evaporation of solvents or exposure to heat. Varnishes of this kind have been described, for example, by A. Vrancken (Farbe und Lack 83, 3 (1977) 171).

In one preferred embodiment the two varnish layers have a maximum color contrast to one another.

This is because the label of the invention is composed preferably of an opaque top layer, which can be easily burnt through by a laser beam, and a bottom, second layer, in particular in a contrasting color to the first, the bottom layer being such that it is not easily burnt through by the laser beam.

In another preferred embodiment an additional adhesive layer with a thickness of from 5 to 70 μm is applied to the second varnish layer, and, if necessary, a release paper is deposed on said adhesive layer.

The third layer, comprising a pressure sensitive adhesive, hotmelt adhesive or reactive adhesive or the like, is intended for the formation of an adhesive bond with a substrate. The thickness of the adhesive layer is preferably from 5 to 70 μm, in particular from 10 to 30 μm.

As a result of the security feature there is no adverse effect on the laser label already present; there are no changes in the mechanical, physical, and chemical resistance properties. The label suffers no detractions from the application standpoint; with respect to laser inscribability, or legibility of the information.

The first varnish layer is applied to the support carrier sheet and is cured under effectively oxygen-free conditions by exposure to a high-energy (150 to 500 kV) electron beam. In order to improve the adhesion between the two varnish layers, a slightly tacky surface can be brought about by means of a particularly low dose or by means of a certain amount of oxygen.

Atop this first layer the second is applied and is cured likewise by electron beams. This is followed, where appropriate, by coating with the adhesive and subsequently, if desired, by covering with the protective paper. Thereafter the polyester film is removed so that the free surface of the first, top layer is exposed. Depending on the form of the surface of the polyester film, this top layer is glossy, smooth, matt or embossed.

The label of the invention features a multiplicity of advantages which were not foreseeable in this way for the skilled worker.

Following application, the labels are quickly perceived, optically visible, and tactile.

Identification is possible without auxiliary means; in other words, an authenticity check can be made without UV or IR lamps, etc.

Since identification is unambiguous, the risk of a misassessment is low.

The label is distinguished by a very high level of anticounterfeit security on the basis of the special production process. This is because the printing process means that the risk of copying of laser-inscribable label material with a negative impression is very small.

Rapid communication and implementation of the anticounterfeit security is possible; in other words, rapid information to all important examination sites, such as workshops, police, customs, for example, without particular complexity.

Implemented in the first, laser-inscribable varnish layer is a customer-individual identification, which as a depression in the varnish layer is visible, perceptible, and measurable. This identification may include, subject to the reserve of more comprehensive experimental results, not only various kinds of graphics and logos but also text. Combinations of both are possible as well. For example, it would be possible to incorporate the logo of the automobile manufacturer, in conjunction with the text, into the surface of the sheet. This symbol will be spread over the entire width of the material, thereby ensuring that in every label produced (of a size to be defined) there is at least one of these originality-assuring symbols. As already mentioned, the depression in question is a very fine depression in the surface, in conjunction with a roughening. Accordingly, the security symbol is distinguished by visibility with the eye, by virtue of its mattness, and by sensory measurability, by virtue of its depression.

This “embossing” is prepared in a step which comes before the actual production operation, by means of a kind of “negative”, before then being integrated into the highly complex and almost completely inimitable production process of the standard laser sheets.

Accordingly, the copying of this originality feature is not possible.

The invention is illustrated below with reference to two examples, without thereby restricting it. In the drawing

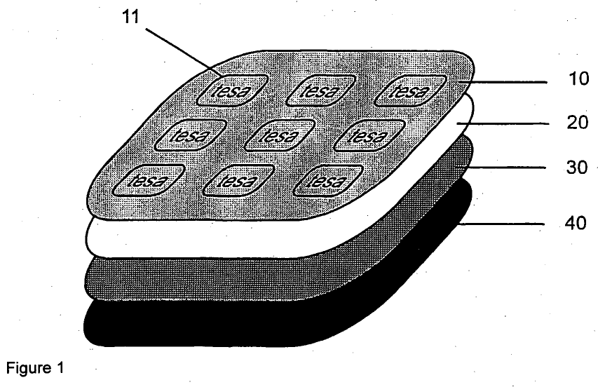

FIG. 1 shows the construction of the label of the invention.

In the construction of the label of the invention, shown in FIG. 1, the first varnish layer 10 is located on the second, thicker varnish layer 20, which in accordance with one preferred embodiment is on a layer of an adhesive 30, in particular a pressure-sensitive adhesive, which is covered with a release paper 40.

In the first varnish layer 10 it is possible to perceive the indentations 11 formed by coating the first varnish layer 10 on a printed support carrier sheet. The regular pattern which has been chosen here is the text “tesa”®, which is surrounded with an outline.

### EXAMPLE 1

The substrate to be printed, in this case a polyester film (Hostaphan RN 75®) from Mitsubishi, is treated by corona treatment, prior to printing, in such a way as to produce the desired surface tension. This can be done using a VETAPHON Corona Plus DK—E-Treater ET 2— with an output of from 0.2 to 2.0 kW. For further processing it is advantageous to adjust the surface tension to >50 mN/m.

A cationically curable UV varnish, SICPA 360076 from SICPA, Aarberg, is used, which is tinted blue. The printing ink is optimized for processing by admixing 5% by weight of an agent which prevents it sticking to the cylinders.

Using an ARSOMA em 410 or em 510 UV flexographic printing machine, the pretreated polyester film is printed at a machine speed of 30 m/min via a flexographic printing station. Precisely defined ink transfer to the flexographic printing plate is effected by means of a corresponding engraved roller in a negative doctor blade process. Thereafter, ink is transferred from the plate to the film substrate in an ink height of from 3 to 4 μm.

The ink applied to the film substrate is cured by means of powerful UV lamp tubes. The equipment used for this purpose is a GEW Micro UV station with a lamp output of 110 W/cm at a wavelength of 365 nm. The support carrier sheet is now ready for further processing.

A commercial polyurethane acrylate made from long-chain polyesterdiol, aliphatic diisocyanate, and terminal acrylic groups (molecular weight approximately 1500, functionality 2) is then mixed with 20% of hexanediol bisacrylate to give a liquid with a high viscosity of approximately 10 Pa*s.

This is used to prepare:

a black paste A, by dispersing with 12% carbon black FCF (average particle diameter 23 μm) on a triple-roll mill, and

a white paste B, by dispersing with 45% of a rutile pigment stabilized with Al and Si (TiO₂ content 90%, density 3.9 g/cm²).

Paste A is coated in a thickness of 10 μm onto a biaxially oriented and embossed polyester film 50 μm thick and is cured by an electron beam of 350 keV with a dose of 1 Mrad under inert gas.

Thereafter, a white paste B is applied with a thickness of 50 μm and curing is again carried out with the electron beam under inert gas, with a dose of 3 Mrad.

To this product there is applied a pressure sensitive adhesive in accordance with DE 15 69 898 A1, so that the layer after drying has a thickness of 20 μm. The pressure sensitive adhesive is covered with commercial release paper.

The polyester film is then removed so that the black surface of the product, which carries embossments and is otherwise mirror-smooth, is revealed.

This surface can be rapidly inscribed with a barcode, for example, using a controllable power laser. The contrast is sufficiently high that the code can be read without error from a distance of more than 1 m using a reading device.

Heating of the material at 200° C. for 1 hour results in shrinkage of less than 10% in the lengthwise and transverse directions. Immersion in water and/or weathering in a weathermometer for 500 h results in no impairment.

1. A label with enhanced proof against counterfeiting, comprising at least one varnish layer obtainable by applying the varnish layer to a printed support carrier sheet and subsequently curing it.

2. The label as claimed in claim 1, comprising at least a first and second varnish layer, wherein said a second varnish layer is applied atop the first varnish layer and is subsequently cured.

3. The label as claimed in claim 1, wherein said first varnish layer has a thickness of from 1 to 20 μm, and the and said second varnish layer has a thickness of from 20 to 500 μm.

4. The label as claimed in claim 2, wherein the two varnish layers exhibit a color contrast with respect to one another.

5. The label as claimed in claim 1, comprising an adhesive layer on the first or second varnish layer with a thickness of from 5 to 70 μm, and optionally a release paper deposed on said adhesive layer.

6. The label as claimed in claim 1, wherein said support carrier sheet is a polymer film.

7. The label as claimed in claim 1, wherein the printing on the support carrier sheet has a height of from 0.1 μm to 15 μm.

8. The label as claimed in claim 1, wherein the printing on the printed support carrier layer makes an impression in the first of said at least one varnish layers that is or are applied to it in the form of a depression of from 0.1 to 15 μm.

9. The label as claimed in claim 3, wherein the thickness of said first varnish layer is from 5 to 15 μm, and the thickness of said second varnish layer is from 30 to 100 μm.

10. The label as claimed in claim 6, wherein said polymer film is a polyester film.

11. The label as claimed in claim 7, wherein said height of said printing is from 1 to 5 μm.

12. The label as claimed in claim 8, wherein said depression is from 1 to 5 μm.
